(19) United States
(12) Patent Application Publication
(10) Pub. No.: US 2006/0040541 A1
(43) Pub. Date: Feb. 23, 2006

(54) Self sealing electrical connector

(76) Inventor: James T. Vaughn, Greenville, SC (US)

Correspondence Address: John B. Hardaway, III;NEXSEN PRUET, LLC, P.O. Box 10107, Greenville, SC, 29603, US

(21) Appl. No.: 10/920,002

(22) Filed: Aug. 17, 2004

(51) Int. Cl. H01R 13/28

(52) U.S. Cl. 439/289

(57) ABSTRACT

An improved electrical connection is effected by a connector having anaerobic sealant which upon insertion of electric leads not only seals the connection against oxidation but also provides bonding which physically strengthens the connection between leads joined end to end.

### BACKGROUND OF THE INVENTION

This invention relates generally to the art of electrical connectors, and more particularly, to sealing an electrical connection in which a pair of aligned electrical conductors are conductively interconnected in a butt joint by a crimped ferrule.

Various connections have been devised for joining aligned electric conductors to one another including the use of a crimpable metal ferrule which is surrounded by an insulating sleeve. Even though the insulating sleeve has a close fitting relation with the insulation covering of the electrical conductors and with the ferrule, the sealing fit has not proven entirely satisfactory to prevent long term oxidation of the conductor terminals and ferrule.

### BRIEF SUMMARY OF THE INVENTION

This invention provides an improved connection between a pair of aligned electric leads or conductors which provides an airtight seal and strain relief for the connection. A connector is provided having anaerobic sealant which not only provides an air tight seal for the connection but also bonds the conductor insulation to the plastic sheath surrounding the inner metallic ferrule of the connector. The improved connector is manufactured by a unique method which includes the step of applying anaerobic sealant to interior cylindrical surfaces at each end of the plastic sheath of the connector.

### BRIEF DESCRIPTION OF THE DRAWINGS

This invention is illustrated by the accompanying drawings in which:

FIG. 1 is an end view of a connector for butt connecting a pair of electric leads;

FIG. 2 is a section take on the line 2-2 in FIG. 1;

FIG. 3 is a section view similar to FIG. 2 showing application of sealant to the interior cylindrical surfaces at each end of the plastic sheath of the connector;

FIG. 4 is an end view of the connector after application of the sealant;

FIG. 5 is a section take on the line 5-5 in FIG. 4;

FIG. 6 is a section view of the connector showing electric leads inserted therein, and

FIG. 7 is a view similar to FIG. 6 showing the metal ferrule of the connector crimped on the wires of the aligned leads.

### DETAILED DESCRIPTION OF THE INVENTION

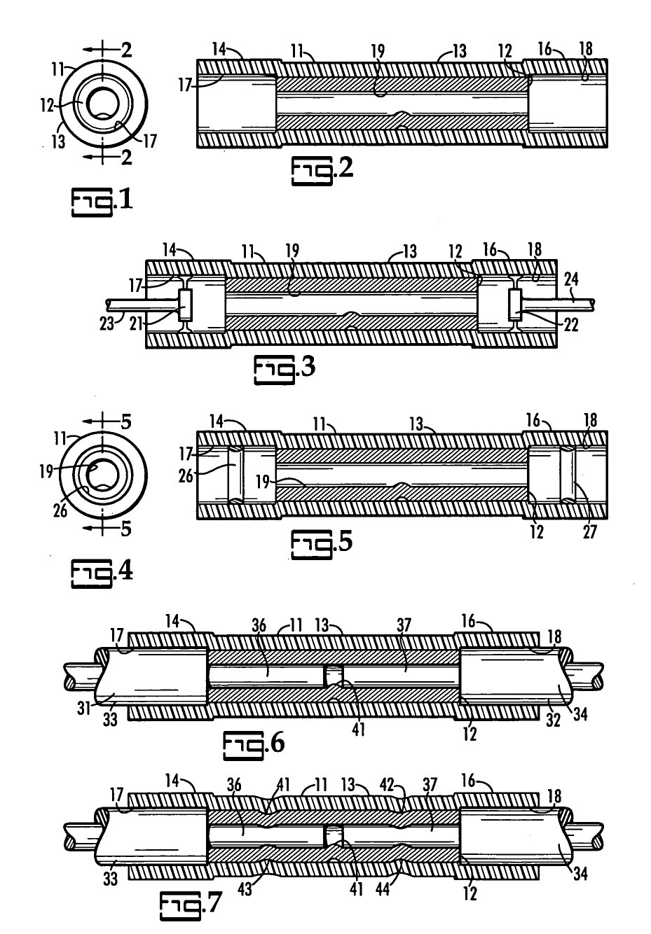

FIGS. 1 and 2 illustrate an electrical connector 11 having a tubular metal ferrule 12 encased in a heat shrunk plastic sheath 13 of tubular configuration. Opposite end portions 14, 16 of the tight fitting sheath 13 extend beyond the axially opposite ends of the ferule 12 and the present radially inward facing cylindrical surfaces 17, 18 adapted to receive the cylindrical insulation of aligned electric leads. The metal ferrule 12 has a cylindrical interior passage or central bore 19 extending between its axially opposite ends which is adapted to receive wires of the aligned electrical leads.

Referring to FIG. 3, a pair of sealant delivery nozzles 21, 22 have been inserted axially into the end portions 14, 16 of the plastic sheath 13 and are discharging a ring of anaerobic sealant in the form of a high viscosity gel to the cylindrical surfaces 17, 18, respectfully. Sealant is delivered from a pressurized source, not shown, by way of conduits 23, 24. After applying the sealant, the nozzles 21, 22 are withdrawn and adhesive gel rings 26, 27, formed by the application step of the manufacturing method, remain adhesively secured to the interior cylindrical surfaces 17, 18, respectively, of the plastic sheath 13. The connector 11 is now ready for packaging for distribution and marketing. The anaerobic sealant 26, 27 will remain in a gel state because of its exposure to oxygen in the air.

FIGS. 6 and 7 illustrate steps in the use of the connector 11. A pair of aligned electric leads 31, 32 have had the tubular plastic insulation 33, 34 removed from confronting ends of their cylindrical conductors or wires 36, 37 a sufficient distance to place their confronting ends near a dimple 41 at the longitudinal center of the metal ferrule 12. Insertion of the insulation sleeves 33, 34 into the openings in the sheath 13 formed by the radially inward facing cylindrical surfaces 17, 18 spreads the anaerobic adhesive 26, 27 between the radially confronting surfaces of the sleeves 33, 34 and surfaces 17, 18 and at the same time cuts off the supply of oxygen to the anaerobic sealant. In absence of oxygen, the anaerobic adhesive solidifies and bonds the sleeves 33, 34 to the interior surfaces 17, 18 of the plastic sheath 13 of the conductor 11. This bonding of the sleeves 33, 34 to the sheath 13 adds mechanical strength to the connection between the leads 31, 32. Strain relief is thus afforded for the physical connection effected by the crimping of the ferrule 12 in the next manufacturing step shown in FIG. 7, which results in indentations 41, 42, 43, 44 in the ferrule 12.

The connector illustrated in FIGS. 4 and 5, as manufactured by the herein outlined method, is ready for use in making an electrical butt connection. The anaerobic sealant 26 27 remains in gel form until deprived of oxygen, which occurs upon insertion of the leads 31, 32. The anaerobic sealant not only seals the connection thereby preventing oxidation of the metal ferrule and lead wires but also bonds the sleeves of the leads to the sheath of the ferrule, thus physically strengthening the connection.

What is claimed is:

1. A connector for butt connecting a pair of electrical leads comprising:
a tubular metal ferrule with a cylindrical interior passage extending between its axially opposite ends adapted to receive end portions of conductor wires of a pair electric leads from which the cylindrical insulation sleeve has been removed,
a plastic cylindrical sheath encompassing said ferrule in a light fitting manner and extending axially outward beyond said opposite ends of said ferrule presenting radially inward facing cylindrical surfaces adapted to receive said cylindrical insulation sleeves of said pair of leads, respectively, and
an anaerobic sealant adhered to each of said radially inward facing cylindrical surfaces of said plastic sheath.

2. The connector of claim 1 wherein said sealant is in the form of a ring on each of said radially inward facing cylindrical surfaces on said plastic sheath.

3. A method of manufacturing an electrical connector comprising the steps of:
providing a tubular metal ferrule having a cylindrical interior passage adapted to receive wires of aligned insulated electrical leads and a plastic cylindrical sheath encompassing and extending beyond the axially opposite ends of said ferrule presenting radially inward facing cylindrical surfaces adapted to receive the cylindrical insulation of electrical leads, and
applying an anaerobic sealant in the form of a high viscosity gel on each of said radially inward facing cylindrical surfaces of said sheath.

4. The method of claim 3 wherein said application of sealant results in a ring of sealant on each of said radially inward facing surfaces of said sheath.

5. A method of forming an electrical connection comprising the steps of:
providing a pair of electrical leads of the type having a cylindrical conductor wire covered by a cylindrical insulation sleeve,
removing a portion of said insulation sleeve from an end of each of said leads,
providing a connector having a tubular metal ferrule with a cylindrical interior passage adapted to receive said wires of said electrical leads, a plastic cylindrical sheath encompassing and extending beyond the axially opposite ends of said ferrule presenting radially inward facing cylindrical surfaces adapted to receive said cylindrical insulation sleeves of electrical leads and an anaerobic sealant in the form of a high viscosity gel on each of said radially inward facing cylindrical surfaces of said sheath, and
inserting said leads into said connector, and
crimping said metal ferrule.

6. The method of claim 5 wherein sealant forms a ring on each of said radially inward facing cylindrical surfaces of said sheath.
